(19) United States
(12) Patent Application Publication
(10) Pub. No.: US 2008/0265694 A1
(43) Pub. Date: Oct. 30, 2008

(54) Manufacturing process for a motor stator assembly and structure thereof

(76) Inventor: YEN-PENG CHUANG, Banciao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,577

(22) Filed: Mar. 7, 2008

(30) Foreign Application Priority Data
Apr. 30, 2007 (TW) 96115408

(51) Int. Cl. H02K 1/12; B29C 45/00; H02K 15/02

(52) U.S. Cl. 310/43; 264/328.1; 310/259

(57) ABSTRACT

A manufacturing process for a motor stator assembly includes the following steps. A plurality of stator segments is manufactured. The stator segment includes an inner ring portion, a connection rib and an outer ring portion. The connection rib is connected between the inner ring portion and the outer ring portion. The stator segments are disposed at intervals in a mold. By using a plastic injection molding method, an insulating unit is formed on the surface of the stator segments. The adjacent inner ring portions are connected together via the insulating unit to form a full circle. There is a gap between two adjacent outer ring portions. Thereby, it is handy and convenient to perform the wire-winding process for the motor stator assembly.

### BACKGROUND OF THE INVENTION

1. Field of the Invention

The present invention relates to a manufacturing process for a motor stator and a structure thereof. In particular, this invention relates to a manufacturing process for a motor stator assembly and an inner rotary motor stator using the manufacturing process.

2. Description of the Related Art

Motors are popular driving devices in industry. A motor has a stator and a rotor. The stator is a stationary element, and the rotor is a rotating element. The rotor utilizes the magnetic force between the stator and the rotor to rotate to generate the driving energy. The magnetic force is generated from a permanent magnet or an electromagnet. Therefore, the stator or the rotor of the motor can be made of a permanent magnet or an electromagnet.

The stator of the inner rotary motor of the prior art includes an outer ring body, a connection rib and an inner ring body. The outer ring body is a closed circular body. The inner ring body has gaps that are disposed at intervals. The connection rib is connected between the outer ring body and the inner ring body. The inner ring body is used for receiving the rotor. The connection rib is wound with a metal wire in a lengthwise direction. When current is conducted to the metal wire, the stator forms an electromagnet. Because the outer ring body is a closed body, the wire-winding machine winds the wire at the two sides of the connection rib in an inner winding method from the gaps of the inner ring body. However, this method merely can be implemented on the inner rotary motor with large dimensions. For an inner rotary motor with small dimensions, the wire-winding process usually is implemented by hand, especially for the small inner rotary motor with high rotation speed. For the small inner rotary motor with high rotation speed, the diameter of the metal wire is large and the circle number of the winding-wire is less. It is impossible to use the wire-winding machine to perform the wire-winding process in an inner winding method. It is time-consuming to perform the wire-winding process by an artificial method. The efficiency is low.

### SUMMARY OF THE INVENTION

One particular aspect of the present invention is to provide a manufacturing process for a motor stator and a structure thereof. The wire-winding process for the motor stator is simplified so that the manufacturing efficiency of the motor stator is enhanced.

The manufacturing process for a motor stator assembly includes the following steps. A plurality of stator segments is manufactured. The stator segment includes an inner ring portion, a connection rib and an outer ring portion. The connection rib is connected between the inner ring portion and the outer ring portion. The stator segments are disposed at intervals in a mold. By using a plastic injection molding method, an insulating unit is formed on the surface of the stator segments. The adjacent inner ring portions are connected together to form a full circle via the insulating unit. There is a gap between two adjacent outer ring portions.

The assembled motor stator structure includes a plurality of stator segments, and an insulating unit. The stator segments are disposed at intervals. Each of the stator segments includes an inner ring portion, a connection rib and an outer ring portion. The connection rib is connected between the inner ring portion and the outer ring portion. The insulating unit covers on the surface of the inner ring portions, the connection ribs and the outer ring portions. The adjacent inner ring portions are connected via the insulating unit. There is a gap between two adjacent outer ring portions.

The present invention has the following characteristics. Because there is a gap between two adjacent outer ring portions, the wire-winding machine can be used to wind the metal wire around the connection rib in an external winding method via the gaps of the inner ring body for the inner rotary motor with small dimensions. It is different from the prior art. Therefore, it is convenient to wing the wire. The manufacturing speed is increased and the manufacturing efficiency of the motor stator is enhanced.

For further understanding of the invention, reference is made to the following detailed description illustrating the embodiments and examples of the invention. The description is only for illustrating the invention and is not intended to limit of the scope of the claim.

### BRIEF DESCRIPTION OF THE DRAWINGS

The drawings included herein provide a further understanding of the invention. A brief introduction of the drawings is as follows:

FIG. 1 is a flow chart of the manufacturing process for the assembled motor stator of the present invention;

FIG. 2 is a flow chart of the wire-winding process and the process for embedding the stator segments into the stator shell of the assembled motor stator of the present invention;

FIG. 3 is a schematic diagram of the stator segment of the present invention;

FIG. 4 is a schematic diagram of the stator segment of the present invention circularly disposed at intervals;

FIG. 5 is a cross-sectional view of the stator segment in FIG. 4 connected with the insulating unit;

FIG. 6 is a cross-sectional view of the stator segment in FIG. 5 wound with a metal wire;

FIG. 7 is a schematic diagram of the stator connection part of the present invention;

FIG. 8 is a cross-sectional view of the stator segment in FIG. 6 assembled with the wound with the stator connection part;

FIG. 9 is a schematic diagram of the stator segment and the stator connection part of the present invention embedded into the stator shell;

FIG. 10 is a schematic diagram of the stator segment of the present invention embedded into the stator shell; and

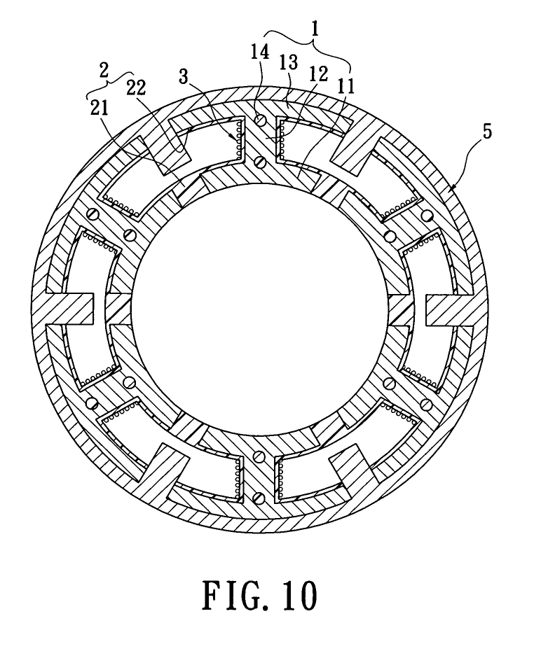

FIG. 11 is another schematic diagram of the stator segment of the present invention embedded into the stator shell.

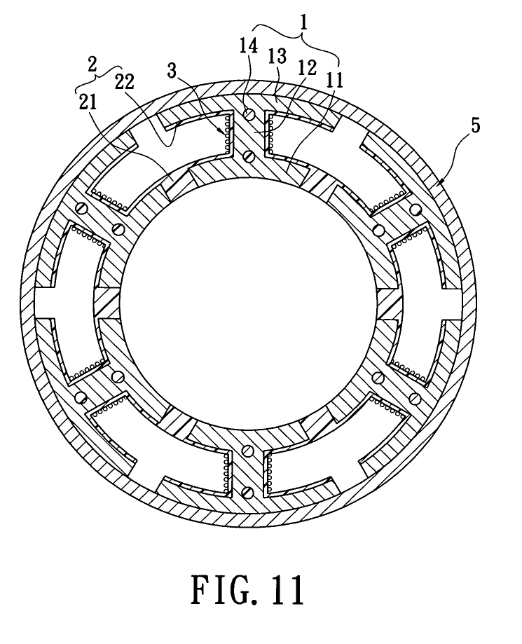

### DETAILED DESCRIPTION OF THE PREFERRED EMBODIMENTS

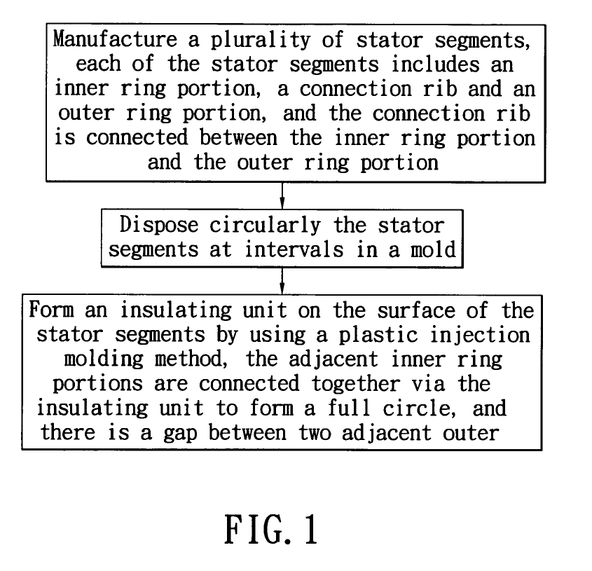

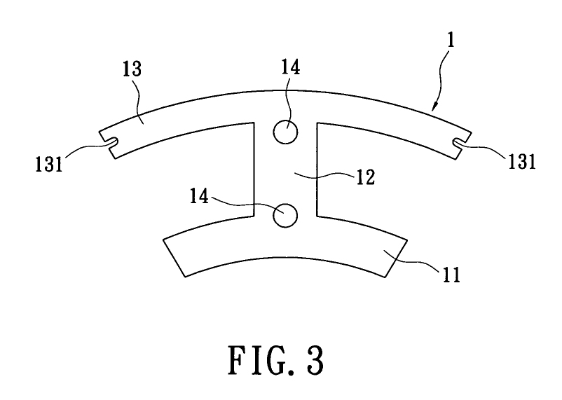

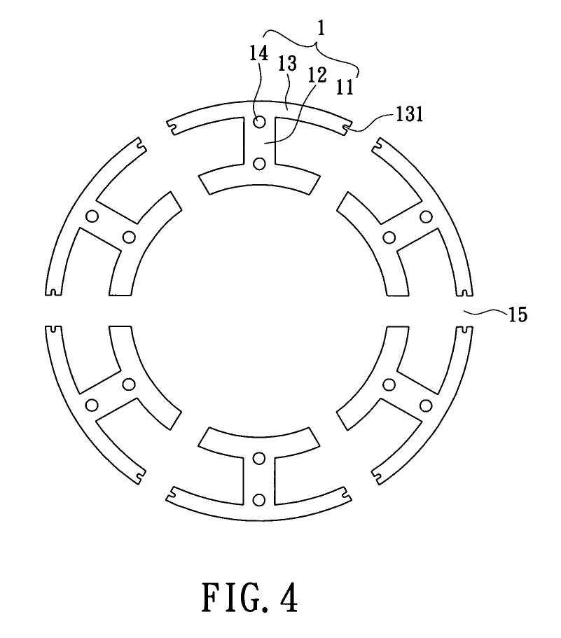

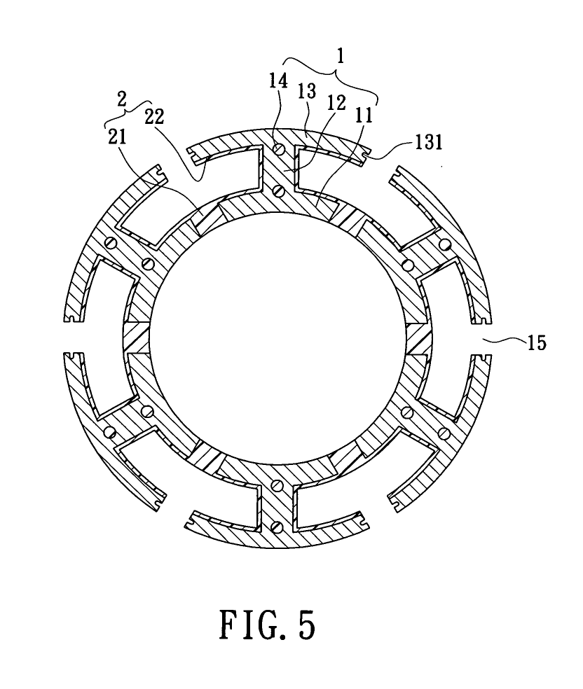

Reference is made to FIG. 1 (also referring to FIGS. 3-5), which shows a flow chart of the manufacturing process for the assembled motor stator of the present invention. The manufacturing process for a motor stator assembly includes the following steps.

(1) A plurality of stator segments 1 is manufactured. Each of the stator segments 1 includes an inner ring portion 11, a connection rib 12 and an outer ring portion 13. The inner ring portion 11 and the outer ring portion 13 are arc shaped. The connection rib 12 is connected between the inner ring portion 11 and the outer ring portion 13. Each of the two opposing sides of the outer ring portion 13 has a wedging slot 131. The surface of the stator segment 1 has a concave slot 14.

(2) The stator segments 1 are disposed at intervals in a mold.

(3) By using a plastic injection molding method, an insulating unit 2 is formed on the surface of the stator segments 1. The insulating unit 2 includes an insulating connection layer 21 and an insulating cover layer 22. The insulating connection layer 21 is located between the two adjacent inner ring portions 11. The adjacent inner ring portions 11 are connected via the insulating connection layer 21 to form a full circle. The insulating cover layer 22 covers on the surface of the inter ring portions 11, the connection ribs 12 and the outer ring portions 13. Through the concave slot 14 of the stator segment 1, the connection strength between the insulating cover layer 22 and the stator segment 1 is enhanced. There is a gap 15 between two adjacent outer ring portions 13.

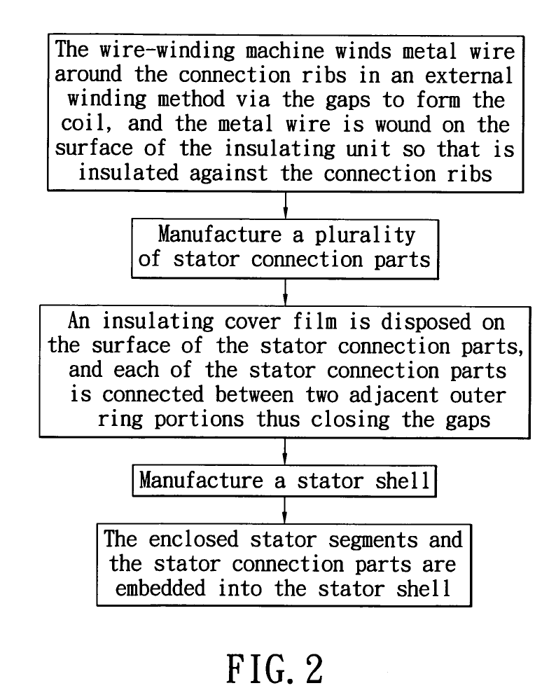

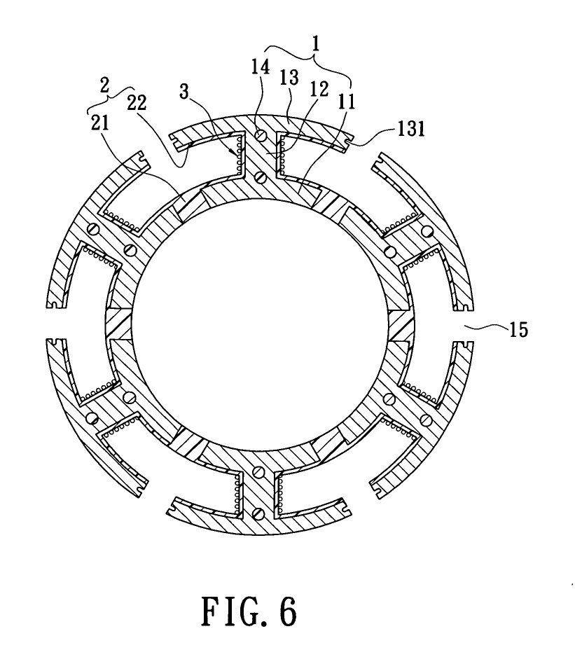

Reference is made to FIG. 2 (also referring to FIGS. 6-9), which shows a flow chart of the wire-winding process and the process for embedding the stator segments into the stator shell of the assembled motor stator of the present invention. The following steps are included.

(1) The wire-winding machine winds metal wire 3 around the connection ribs 12 using an external winding method via the gaps 15 to form the coil. The metal wire 3 is wound on the surface of the insulating unit 12 so that is insulated against the connection ribs 12.

(2) A plurality of stator connection parts 4 is manufactured. Each of the two opposing sides of the stator connection parts 4 has a convex column 41. The surface of the stator connection part 4 has a concave slot 42.

(3) An insulating cover film (not shown in the figure) is located on the surface of the stator connection parts 4. Through the concave slot 42 of the stator connection part 4, the connection strength between the insulating cover film and the stator connection part 4 is enhanced.

(4) The convex columns 41 of the stator connection parts 4 are wedged into the wedging slots 131 of the outer ring portions 13 to close the gaps 15.

(5) A stator shell 5 is manufactured.

(6) The enclosed stator segments 1 and the stator connection parts 4 are embedded into the stator shell 5.

Reference is made to FIGS. 3˜5, which show the assembled motor stator structure. The assembled motor stator structure includes a plurality of stator segments 1, and an insulating unit 2. The stator segments 1 are circularly disposed at intervals. Each of the stator segments 1 includes an inner ring portion 11, a connection rib 12 and an outer ring portion 13. The shape of the inner ring portion 11 and the outer ring portion 13 is arc. The connection rib 12 is connected between the inner ring portion 11 and the outer ring portion 13. Each of the two opposing sides of the outer ring portion 13 has an arced wedging slot 131. The top surface and the bottom surface of the stator segment 1 have concave slots 14.

The insulating unit 2 includes an insulating connection layer 21 and an insulating cover layer 22. The insulating connection layer 21 is located between the two adjacent inner ring portions 11. The adjacent inner ring portions 11 are connected together via the insulating connection layer 21 to form a full circle. There is a gap 15 between two adjacent outer ring portion 13. The inner ring portions 11 are used for receiving the rotor mechanism (not shown in the figure). The insulating cover layer 22 covers on the surface of the inter ring portions 11, the connection ribs 12 and the outer ring portions 13. Through the concave slot 14 of the stator segment 1, the connection strength between the insulating cover layer 22 and the stator segment 1 is enhanced.

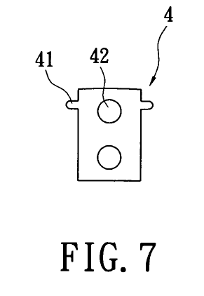

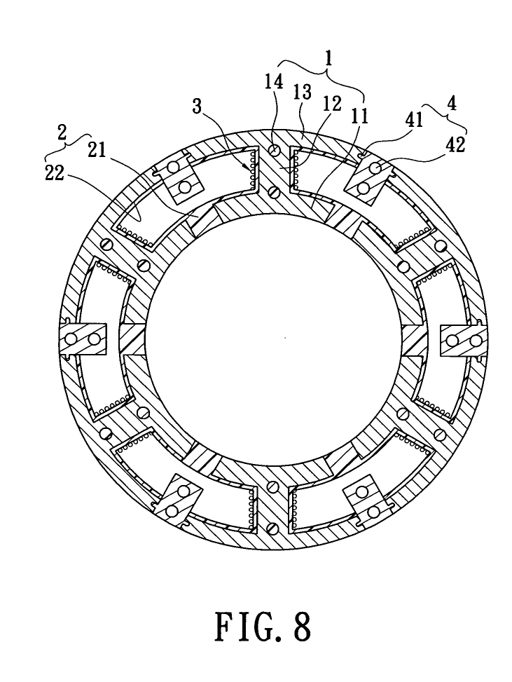

As shown in FIG. 6, the metal wire 3 is wound around the connection rib 12, and the metal wire 3 winds around the surface of the insulating unit 2 to insulate against the stator segment 1. As shown in FIGS. 7 and 8, each of the gaps 15 is filled with a stator connection part 4. Each of the two opposing sides of the stator connection parts 4 has a convex column 41. The top surface and the bottom surface of the stator connection part 4 have concave slots 42. An insulating cover film is disposed on the stator connection part 4. Through the concave slots 42 of the stator connection part 4, the connection strength between the insulating cover film and the stator connection part 4 is enhanced. The convex columns 41 of the stator connection parts 4 are respectively wedged into the wedging slots 131 of the outer ring portions 13 (as shown in FIG. 3). The stator connection parts 4 close the gaps 15. The stator connection parts 4 are used as a conductor between the stator segments 1.

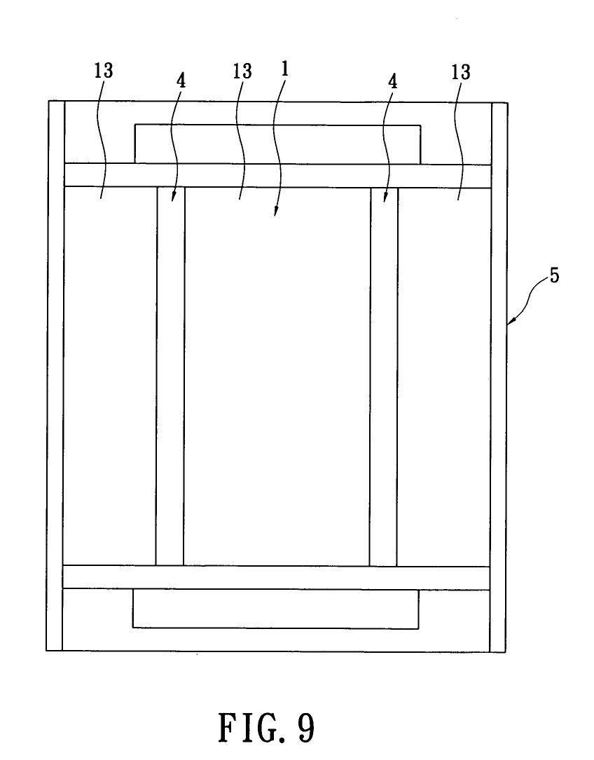

As shown in FIG. 9, the enclosed stator segments 1 and the stator connection parts 4 are embedded into the hollow stator shell 5 to form a stator.

By using the manufacturing process for manufacturing process for a motor stator, the motor stator with different dimensions can be produced. When the dimensions of the motor stator are reduced to a pre-determined value, a metallic stator shell 5 can be directly used as the conductor between the stator segments 1. It does not need to use the stator connection parts 4 as the conductor between the stator segments 1.

The present invention has the following characteristics:

1. Because there is a gap 15 between two adjacent outer ring portion 13, the wire-winding machine can be used to wind the metal wire 3 around the connection rib 12 in an external winding method via the gaps 15 for the inner rotary motor with a small dimension. It is different from the prior art. Therefore, it is convenient to wing the wire. The manufacturing speed is increased and the manufacturing efficiency of the motor stator is enhanced.

2. The quantity of the stator segments 1 and the stator connection parts 4 depends on the requirements (such as the number of the poles of the motor). Therefore, it is convenient and handy to assembling the motor stator.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A manufacturing process for a motor stator assembly, comprising:
manufacturing a plurality of stator segments, wherein each of the stator segments includes an inner ring portion, a connection rib and an outer ring portion, and the connection rib is connected between the inner ring portion and the outer ring portion;
disposing the stator segments at intervals in a mold; and
forming an insulating unit on the surface of the stator segments and between the stator segments using a plastic injection molding method, wherein adjacent inner ring portions are connected via the insulating unit to form a full circle, and there is a gap between two adjacent outer ring portions.

2. The manufacturing process for a motor stator assembly as claimed in claim 1, wherein the stator segments are circularly disposed at intervals.

3. The manufacturing process for a motor stator assembly as claimed in claim 1, wherein the inner ring portion and the outer ring portion are arc shaped.

4. The manufacturing process for a motor stator assembly as claimed in claim 1, wherein the surface of the stator segment has a concave slot.

5. The manufacturing process for a motor stator assembly as claimed in claim 1, wherein the insulating unit includes an insulating connection layer and an insulating cover layer, the insulating connection layer is located between two adjacent inner ring portions, the adjacent inner ring portions are connected together via the insulating connection layer to form a full circle, and the insulating cover layer covers on the surface of the inter ring portions, the connection ribs and the outer ring portions.

6. The manufacturing process for a motor stator assembly as claimed in claim 1, wherein a metal wire is wound around the connection rib, and the metal wire is wound upon the surface of the insulating unit to insulate against the stator segment.

7. The manufacturing process for a motor stator assembly as claimed in claim 6, wherein each of the gaps is filled with a stator connection part after the metal wire is wound around the connection rib, each of two opposing sides of the stator connection parts has a convex column, each of two opposing sides of the outer ring portions has a wedging slot, and the convex columns are wedged into the wedging slots to close the gaps.

8. The manufacturing process for a motor stator assembly as claimed in claim 7, wherein the surface of the stator connection part has a concave slot.

9. The manufacturing process for a motor stator assembly as claimed in claim 7, wherein the stator segments and the stator connection parts are embedded into a stator shell.

10. A motor stator assembly structure, comprising;
a plurality of stator segments, wherein the stator segments are disposed at intervals, each of the stator segments includes an inner ring portion, a connection rib and an outer ring portion, and the connection rib is connected between the inner ring portion and the outer ring portion; and
an insulating unit, wherein the insulating unit covers on the surface of the inner ring portions, the connection ribs and the outer ring portions, the adjacent inner ring portions are connected together via the insulating unit, and there is a gap between two adjacent outer ring portions.

11. The motor stator assembly structure as claimed in claim 10, wherein the stator segments are circularly disposed at intervals.

12. The motor stator assembly structure as claimed in claim 10, wherein the inner ring portion and the outer ring portion are arc shaped.

13. The motor stator assembly structure as claimed in claim 10, wherein the surface of the stator segment has a concave slot.

14. The motor stator assembly structure as claimed in claim 10, wherein the insulating unit includes an insulating connection layer and an insulating cover layer, the insulating connection layer is located between two adjacent inner ring portions, the adjacent inner ring portions are connected together via the insulating connection layer to form a full circle, and the insulating cover layer covers on the surface of the inter ring portions, the connection ribs and the outer ring portions.

15. The motor stator assembly structure as claimed in claim 10, wherein a metal wire is wound around the connection rib, and the metal wire is wound upon the insulating layer to insulate against the stator segment.

16. The motor stator assembly structure as claimed in claim 15, wherein each of the gaps is filled with a stator connection part, each of two opposing sides of the outer ring portions has a wedging slot, each of two opposing sides of the stator connection parts has a convex column, and the convex columns are wedged into the wedging slots.

17. The motor stator assembly structure as claimed in claim 16, wherein the surface of the stator connection part has a concave slot.

18. The motor stator assembly structure as claimed in claim 16, wherein the stator segments and the stator connection parts are embedded into a stator shell.

19. The motor stator assembly structure as claimed in claim 15, wherein the stator segments are embedded into a metallic stator shell.
